(19) United States
(12) Patent Application Publication
(10) Pub. No.: US 2014/0079202 A1
(43) Pub. Date: Mar. 20, 2014

(54) METHOD AND SYSTEM FOR UNIVERSAL INTERNET PROTOCOL (IP) PHONE PROVISIONING

(71) Applicants: Vladimir Movshovich, Mountain View, CA (US); Pavel Maltsev, Santa Clara, CA (US)

(72) Inventors: Vladimir Movshovich, Mountain View, CA (US); Pavel Maltsev, Santa Clara, CA (US)

(73) Assignee: ZULTYS, INC.

(21) Appl. No.: 13/617,510

(22) Filed: Sep. 14, 2012

(51) Int. Cl. H04M 3/42

(52) U.S. Cl. 379/201.12

(57) ABSTRACT

A method for generating a phone provisioning configuration file comprising obtaining a first file, the first file including one or more keys corresponding to phone provisioning configurations; obtaining a set of variables and at least one set of data values from a second file, the data values corresponding to the phone provisioning configurations of at least one phone; determining whether a number of the data values in the at least one set of data values corresponds to a number of the variables; and generating at least one phone provisioning configuration file corresponding to the data values based on the first file, when the number of data values in the at least one set of data values corresponds to the number of variables.

### TECHNICAL FIELD

The subject matter of the present application relates to methods and systems for phone provisioning, in particular, to methods and systems for universal Internet Protocol (IP) phone provisioning.

### BACKGROUND INFORMATION

“Provisioning” is a process of enabling a user to access new or additional services. Provisioning is widely used in the telecommunication technologies and can include provisioning of servers, phones, internet access, and Voice over Internet Protocol (VoIP) networks. A VoIP provisioning includes network provisioning, service provisioning, and device/phone provisioning. A VoIP phone provisioning is a process of defining phone configuration, installing or updating phone firmware, upgrading phone features, and/or installing new applications.

A VoIP phone configuration often includes IP and protocol settings, a layout of programmable buttons, the display text, phone names, etc. In a business environment, where a large number of phones need configuration, network-based provisioning is often used. In a network-based provisioning process, each phone has an associated configuration file stored on a server, such as a provisioning server. The file names of the configuration files are usually defined by a file naming convention that is specified by the phone manufacturer. The file naming convention is often based on a unique phone identifier, such as a Media Access Control (MAC) address or a phone number.

A configuration file is defined according to the rules provided by the phone manufacturer. A typical configuration file is a text file, which can include three types of parameters, i.e., parameters that are common across all phones involved in a configuration or installation, parameters that are common for a group of phones but not all, and parameters that are specific for a particular phone. A typical phone provisioning process may require creating a template or generic configuration file, modifying the group-specific and phone-specific parameters in the template or generic configuration file, saving the modified configuration file under a unique file name, and installing the configuration file to the phone. The provisioning process, however, must be repeated each time for every phone that needs to be provisioned, because each phone may have different group-specific and/or phone-specific parameters. In order to automate the provisioning process, many utility tools, e.g., software programs, have been developed for generating configuration files.

Configuration files for different phones, however, often have different file naming conventions and configuration file formats. For example, each phone manufacturer often defines its own file naming convention and configuration file formats. Even for phones from the same manufacturer, file naming conventions and configuration file formats can be different as a result from of different phone models or different phone firmware versions. Thus, a large number of utilities are developed for different phone manufacturers, models, and firmware versions. Accordingly, service providers or phone installers often need to use several utility tools in a single provisioning process if the provisioning involves phones having different manufacturers, models, or firmware. The number of utility tools needed can become unacceptably large and thus impose a heavy burden on the service provider or phone installer. A service provider or a phone installer may sometimes even need to develop new utility tools if no suitable utility tool is available on the market. The development of new utility tools imposes an extra burden because of the effort caused by, for example, programming and software debugging. Therefore, the provisioning process involving multiple utility tools can be time consuming, labor intensive, error prone, and costly.

### SUMMARY

The present disclosure provides a method for generating a phone provisioning configuration file. According to one embodiment, the method comprises obtaining a first file, the first file including one or more keys corresponding to phone provisioning configurations; obtaining a set of variables and at least one set of data values from a second file, the data values corresponding to the phone provisioning configurations of at least one phone; determining whether a number of the data values in the at least one set of data values corresponds to a number of the variables; and generating at least one phone provisioning configuration file corresponding to the data values based on the first file, when the number of data values in the at least one set of data values corresponds to the number of variables.

The present disclosure further provides a method for generating a first file having one or more keys. According to one embodiment, the method comprises obtaining at least one phone provisioning parameter; obtaining a phone configuration file format; determining whether a second file including sample configurations is available; when the second file is available, generating the first file based on the second file, the at least one phone provisioning parameter, and the phone configuration file format; and when the second file is not available, generating the first file based on the at least one phone provisioning parameter and the phone configuration file format.

The present disclosure further provides a non-transitory computer-readable storage medium storing instructions that, when executed by a computer, cause the computer to perform a method for generating at least one phone provisioning configuration file. According to one embodiment, the method comprises obtaining a first file, the first file including one or more keys corresponding to phone provisioning configurations; obtaining a set of variables and at least one set of data values from a second file, the data values corresponding to the phone provisioning configurations of at least one phone; determining whether a number of the data values in the at least one set of data values corresponds to a number of the variables; and generating at least one phone provisioning configuration file corresponding to the data values based on the first file, when the number of data values in the at least one set of data values corresponds to the number of variables.

The present disclosure further provides a non-transitory computer-readable storage medium storing instructions that, when executed by a computer, cause the computer to perform a method for generating a first file having one or more keys. According to one embodiment, the method comprises obtaining at least one phone provisioning parameter; obtaining a phone configuration file format; determining whether a second file including sample configurations is available; when the second file is available, generating the first file based on the second file, the at least one phone provisioning parameter, and the phone configuration file format; and when the second file is not available, generating the first file based on the at least one phone provisioning parameter and the phone configuration file format.

The present disclosure further provides a system for generating a phone provisioning configuration file. According to one embodiment, the system comprises a processor configured to obtain a first file, the first file including one or more keys corresponding to phone provisioning configurations; obtain a set of variables and at least one set of data values from a second file, the data values corresponding to the phone provisioning configurations of at least one phone; determine whether a number of the data values in the at least one set of data values corresponds to a number of the variables; and generate at least one phone provisioning configuration file corresponding to the data values based on the first file, when the number of data values in the at least one set of data values corresponds to the number of variables; and a memory for storing the at least one phone provisioning file.

### BRIEF DESCRIPTION OF THE DRAWINGS

FIG. 1 is a flowchart representing an exemplary method of phone provisioning.

FIG. 2 is a flowchart representing an exemplary method for generating a Markup Configuration (MUC) file, as shown in FIG. 1.

FIG. 3 is a flowchart representing an exemplary method for generating phone provisioning configuration files, as shown in FIG. 1.

FIG. 4A is a flowchart representing a first embodiment of an exemplary method for generating a phone configuration file, as shown in FIG. 3.

FIG. 4B is a flowchart representing a second embodiment of an exemplary method for generating a phone configuration file, as shown in FIG. 3.

FIG. 5 is a block diagram of an exemplary provisioning system.

### DETAILED DESCRIPTION OF DRAWINGS

Reference will now be made in detail to the exemplary embodiments consistent with the embodiments disclosed herein, examples of which are illustrated in the accompanying drawings. Wherever possible, the same reference numbers will be used throughout the drawings to refer to the same or like parts.

The embodiments described herein provide methods and systems for generating provisioning configuration files for various types of phones, such as a VoIP phone, a mobile phone, and a cordless phone, or any other devices that require provisioning. The methods and the systems provided can also generate provisioning configuration files for various phone models or firmware versions of the same type of phone. In other words, the methods and the systems can generate configuration files having different file-naming conventions, formats, and parameters. Thus, the methods and the systems provided herein may provide a more efficient phone provisioning process, which does not require programming and debugging, and may reduce the cost and effort associated with a large-scale provisioning process.

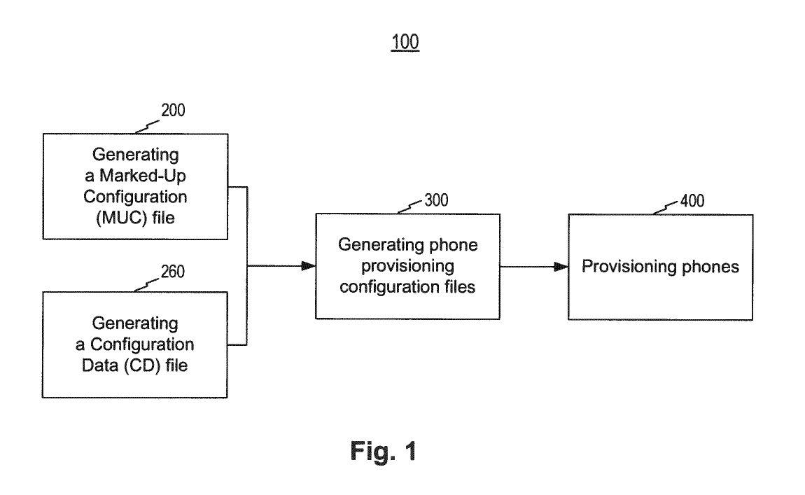

FIG. 1 is a flowchart representing an exemplary method of phone provisioning. The exemplary method includes generating (200) a first file including keys associated with tags, known as a Markup Configuration (MUC) file; generating (260) a second file including variables and data values, known as a Configuration Data (CD) file; generating (300) phone provisioning configuration files based on the first file and the second file, and provisioning or installing (400) phones. Referring to FIG. 1, one of ordinary skill in the art will readily appreciate that the illustrated procedure can be altered to delete steps or further include additional steps.

As shown in FIG. 1, at step 200, an MUC file is generated based on the format defined by a particular phone manufacturer. An MUC file uses a markup language to annotate a text document in a way that is syntactically distinguishable from the text. Examples of markup languages include Extensible Markup Language (XML) and HyperText Markup Language (HTML). A markup language usually includes special characters such as tags to indicate the annotation. As an example, in XML, a markup string begins with an opening tag “<” and ends with a closing tag “>”. In addition, tags can also be used to indicate sections of a markup file. Thus, for example, a section related to “phone1” can begin with “<phone1>” and end with “</phone1>.”

An MUC file can be a text-based file in any format conforming to the definition provided by the particular phone manufacturer. Examples of MUC file formats include XML format, HTML format, and INI format. An MUC file typically includes phone configuration parameters and their corresponding data values. Some of the parameters and data values are common for all phones, but some are not. The data values that are not common can be represented by variables, sometimes also referred to as “keys,” and are marked up with special tags. Keys can then be replaced with the phone-specific data values during configuration file generation. For example, an MAC address can be a key and an MUG file can include “sip line1 auth name : #MAC#.” In the above example, “MAC” is a key, and the two “#”s before and after “MAC” are tags enclosing the key.

One of ordinary skill in the art will readily appreciate that a tag can be any special character or character combination that a user defines. For example, a tag can be “$”, “%”, “{$”, or “$}”. As a result, the MAC address key can also be marked up as “$MAC$”, “%MAC%”, or “{$MAC$}.” A user can define the character or the character combination by, for example, passing command-line arguments to the MUC file generation utility tool. That is, a user can define the tags by including command-line options such as “--opening-tag = {$” and “--closing-tag = $},” where “{$” and “$}” (without quotes) are correspondingly opening and closing tags. In this example, the MUC file generated includes a line of “sip line1 auth name : {$MAC$}.”

An MUC file can include as many parameters and keys as needed. In an MUC file, the parameters can include three types. The first type of parameter includes those parameters that are irrelevant to the provisioning process or have permanent values. The second type of parameter includes those parameters that are relevant in a provisioning process, but are common across all the phones that need to be provisioned. The third type of parameter includes those parameters that are both relevant in a provisioning process and are different among the phones that need to be provisioned.

When an MUC file is generated, the first two types of parameters may have permanent data values and therefore no variables or keys need to be associated with them. The third type parameter, however, may be associated with variables or keys because the actual data value of the third type parameter depends on each individual phone. During a configuration file generating process, phone-specific data values are then assigned to the keys so that the parameters are associated with actual data values.

In an MUC file, the keys and the third type parameters do not necessarily have a one-to-one relationship. That is, the same key can have multiple instances within an MUC file. The association of parameters and multiple instances of keys can be illustrated in the following example.

```
<phone1>
  <msg>
  <mwi msg.mwi.1.callBack=“voice.mail” msg.mwi.1.callBackMode=
  “contact”/>
  </msg>
  <reg reg.1.address=“%MAC%” reg.1.auth.userId=“%MAC%”
reg.1.auth.password=“%PASS%” reg.1.lineKeys=“1” reg.1.label=
“%LABEL%” />
</phone1>
```

In the above example, “mwi msg.mwi. 1 .callBack” and “msg.mwi. 1 .callBackMode” are parameters that are common across all the phones and thus are associated with fixed values, i.e., “voice.mail” and “contact” respectively, without any markup tags. On the other hand, “reg reg. 1 .address”, “reg. 1 .auth.userId”, “reg. 1 .auth.password”, and “reg. 1 .label” are parameters that have phone-specific data values and thus are associated with keys, such as “MAC”, “PASS”, and “LABEL.” In this example, the key “MAC” has two instances. That is, it is associated with both parameter “reg reg. 1 .address” and parameter “reg. 1 .auth.userId.”

An MUC file can be generated by standard text editors, including both command-line text editors and Graphic User Interface (GUI) text editors. Examples of text editors include Windows Notepad, Wordpad, Microsoft Word, Unix Vi, Linux Emacs, Mac OS SimpleText, etc. An MUC file can also be generated by a customized software program that outputs a text file. After the MUC file is generated, it can be used as a template file for generating a large number of phone provisioning configuration files.

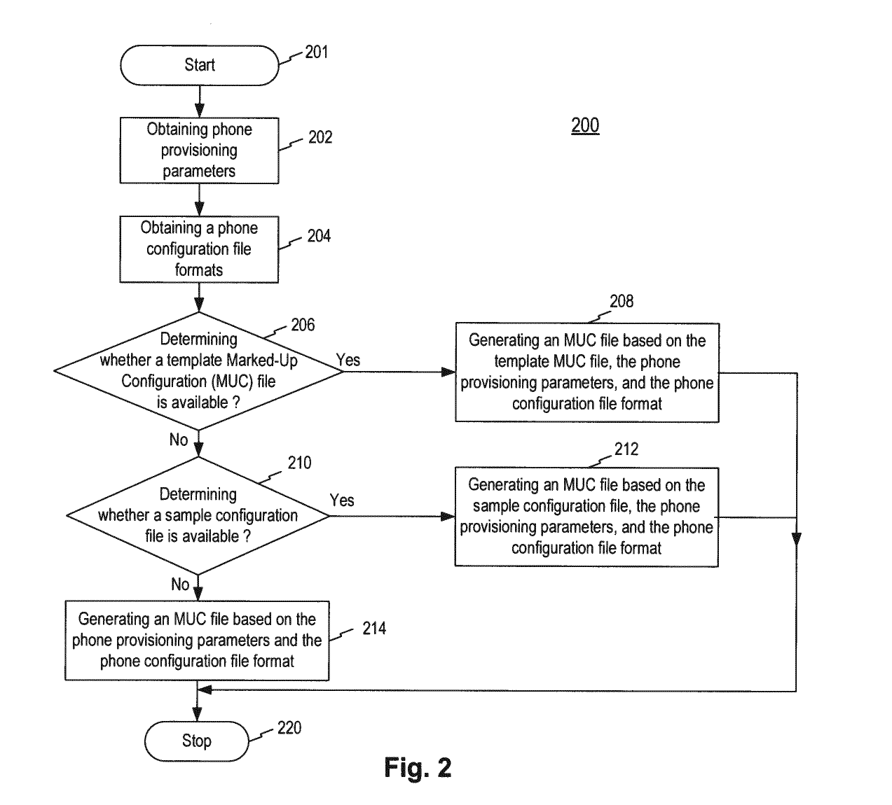

A user may obtain the MUC file by running a customized software program. A user may be provided with the MUC file from, for example, Zultys, Inc., which provides MUC files for widely used phone models. In addition, a user can use the downloaded MUC file as a template file and modify it to obtain a customized MUC file. Moreover, manufacturers also provide examples of the configuration files, from which the MUC files can be generated. Details of the MUC file generation will be discussed in association with FIG. 2.

As shown in FIG. 1, at step 260, a configuration data (CD) file can be generated. A CD file is a data file containing phone-specific data and is typically provided by the user. For example, in the CD file, each phone has a set of data values corresponding to the phone's configuration file name, the MAC address, the IP address, and the display name. A CD file can be any text file with columns and rows. The columns can be separated by column delimiters such as commas or semicolons. The rows can be separated by row delimiters such as line breaks as defined in Unix or Windows. The user can define the delimiter that is used in the CD file. As an example, a user can define a semicolon delimiter by including an option, such as “--column-delimiter=;”, in the command-line.

For illustration purpose, an exemplary CD file is included as following.

| FileName, | MAC, | IP, | DisplayName |
|---|---|---|---|
| 0011223344.cfg, | 0011223344, | 192.168.1.1, | Peter |
| 0011223345.cfg, | 0011223345, | 192.168.1.2, | “Smith, John” |
| 0011223346.cfg, | 0011223346, | 192.168.1.3, | Sam |

In the above example, the CD file contains a table, which comprises four rows and four columns. The rows are delimited by line breaks and the columns are delimited by commas. In this example, the table has a header row and three data rows. The header row includes variables corresponding to the keys in the MUC file. For example, the foregoing table includes four variables, i.e., FileName, MAC, IP, and DisplayName, for indicating the phone provisioning configuration file name, the phone's MAC address, the phone's IP address and the phone's display name, respectively. The MUC file, correspondingly, has keys matching each of the four variables in the CD file. The number of the instances of keys in the MUC file, however, may or may not equal the number of variables in the CD file.

As shown in the illustrating MUC file above, two instances of the key “MAC” are used, one associated with parameter “reg reg. 1 .address” and the other associated with parameter “reg. 1 .auth.userId.” Thus, during the subsequent configuration file generation, both instances will be assigned the same data value corresponding to the variable “MAC” in the CD file. Moreover, it is also readily appreciated by one of ordinary skill in the art that the order of the variables in a CD file does not need to correspond to the order of keys in the MUC file. Thus, in the foregoing example, the four variables, i.e., FileName, MAC, IP, and DisplayName, can be in any order. In some exemplary embodiments, at least one variable, such as the “FileName,” may be a required variable in order to generate the configuration files.

In the foregoing exemplary CD file, each of the three data rows has a set of phone-specific data values corresponding to the variables in the header row. That is, the first data value in each row corresponds to the first variable; the second data value corresponds to the second variable; and so forth. One of ordinary skill in the art, however, can readily appreciate that the correspondence of the variables and data values can be according to other orders, as long as each data value is associated with the a variable.

During the subsequent configuration file generation process, the phone-specific data values in each data row replace keys in copies of the MUC file in order to generate a phone-specific configuration file. As an example, in generating the first phone configuration file, keys in a copy of the MUC file are replaced with the data values in the first data row of the CD file. That is, the phone configuration file will have a MAC address of “0011223344,” an IP address of “192.168.1.1,” and a display name of “Peter.” The phone configuration file will also have a file name of “0011223344.cfg,” which is the first data value in the first row of the exemplary CD file. The data values in a row are usually delimited by, for example, commas. In a situation where a delimiter, such as a comma, is part of a data value, e.g., Smith, John as shown in the second data row, the data values can be enclosed by a double quote, i.e., “Smith, John.” One of ordinary skill in the art can also readily appreciate that the delimiting of data values can also use any method or characters that properly separate one data value from another.

A CD file can be generated by various text editors, including both command-line editors and Graphic User Interface (GUI) editors. Examples of the editors include Windows Notepad, Wordpad, Microsoft Word, Unix Vi, Linux Emacs, Mac OS SimpleText, etc. A CD file can also be generated by a spreadsheet program such as Microsoft Excel or OpenOffice Calc. Moreover, a CD file can also be generated by any customized program that outputs a text file. The CD file is typically generated and provided by a service provider or a phone installer, who has access to the phone-specific data. After the CD file is generated, it can be used as an input file for generating a large number of phone provisioning configuration files.

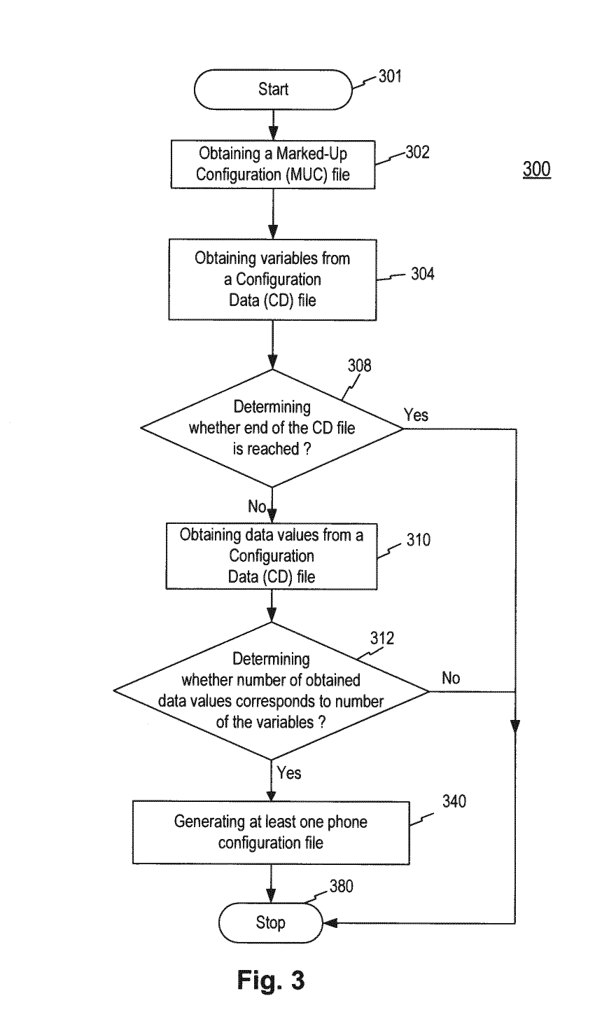

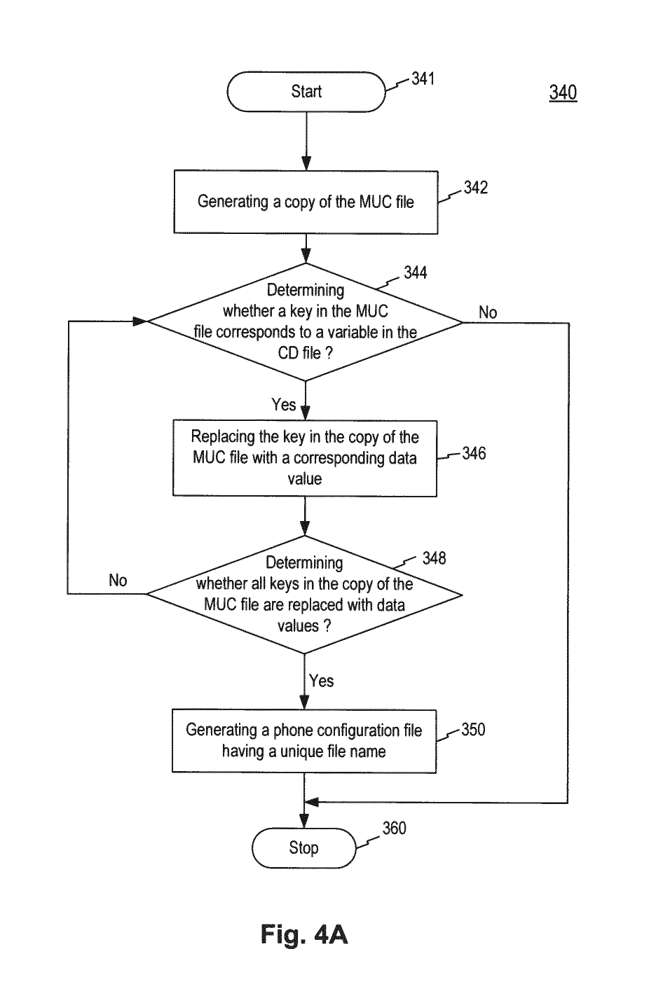

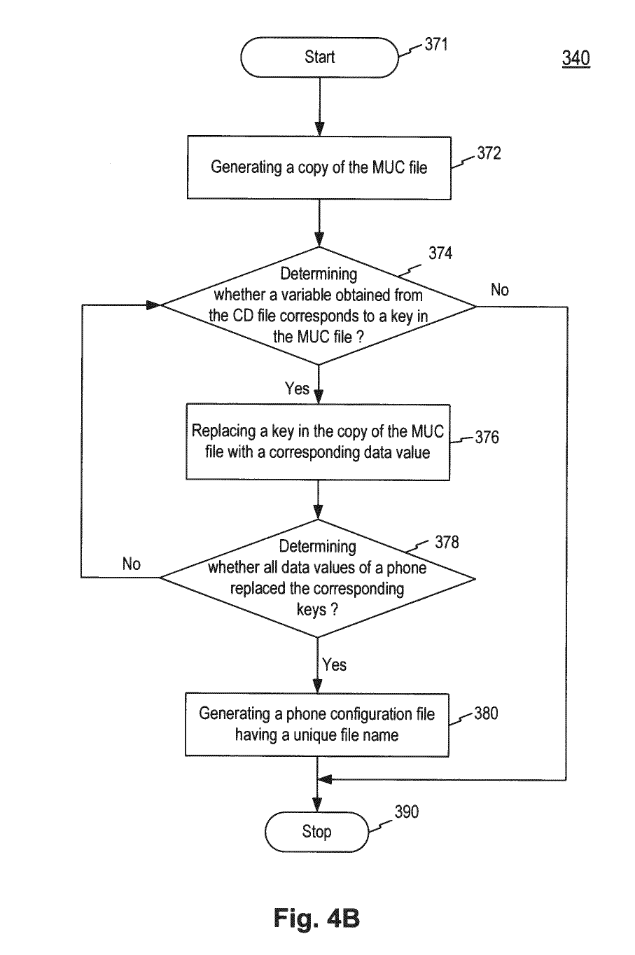

As shown in FIG. 1, at step 300, one or more phone provisioning configuration files, which conform to the formats specified by the phone manufacturer, can be generated based on the MUC file and the CD file. Each configuration file includes phone-specific data values corresponding to the phone's configuration settings. Details of the configuration file generating method will be discussed in association with FIGS. 3 and 4. The generated configuration files can be stored, for example, on a memory device, a hard disk, or any other storage places. Each configuration file has a unique file name, such as a name associated with the phone's MAC address, so that the later provisioning process can determine which configuration file to use. At step 400 (FIG. 1), the service provider or phone installer provisions or configures the phones by invoking the stored configuration files. In some exemplary embodiments, all phones can be provisioned or configured in one procedure, provided that all the configuration files are available.

FIG. 2 is a flowchart representing an exemplary method for generating a Markup Configuration (MUC) file, as indicated at 200 in FIG. 1. After the initial step at 201, the exemplary method 200 for generating a first file having one or more keys, comprises obtaining (202) one or more phone provisioning parameters; obtaining (204) a phone configuration file format; determining (206) whether a second file, known as a template MUC file and including a template of the first file, is available; when the second file is available, generating (208) the first file based on the second file, the one or more phone provisioning parameters, and the phone configuration file format; when the second file is not available, determining (210) whether a third file, known as a sample configuration file and including sample configurations, is available; when the third file is available, generating (212) the first file based on the third file, the one or more phone provisioning parameters, and the phone configuration file format; and when the third file is not available, generating (214) the first file based on the phone provisioning parameters and the phone configuration file format. One of ordinary skill in the art will readily appreciate that the illustrated procedure of FIG. 2 can be altered to delete steps or further include additional steps. For example, steps 206 and 208 can be deleted if a user was not provided with or does not wish to use a template MUC file. In this case, the configuration file can be generated based on the sample configuration file.

After initial step 201, one or more phone provisioning parameters are obtained (202). The phone provision parameters can include, for example, an MAC address, an IP address, and a display name. The obtained phone provisioning parameters can correspond to any one of or combination of the three types of parameters included in the MUC file as discussed above. That is, the parameters can include one or more of the parameters of first type that are irrelevant in a provisioning process, the parameters of second type that are relevant in a provisioning process, but are common across all the phones that need to be provisioned, and the parameters of third type that are both relevant in a provisioning process and are phone-specific. Although all three types of parameters can be obtained, the first type parameter may not need to be obtained because they are irrelevant in the current provisioning process. In some exemplary embodiments, all phones that need to be provisioned may belong to the same phone model or the same phone firmware version. Thus, in these embodiments, only the phone-specific parameters, i.e., the third type parameters, are obtained. In some other embodiments, both phone-specific and group-specific parameters are obtained if needed.

At step 204, the phone configuration format, which is usually specified by a phone manufacturer, is obtained. For example, a phone manufacturer may specify that the configuration file is a text file having an XML format or an INI format, that the configuration file name and/or parameter name are case sensitive or case insensitive, etc.

At step 206, whether a template MUC file is available is determined. The template MUC file can be obtained from, for example, Zultys Inc., which provides MUC files for widely used phones, such as CISCO IP phones, Grandstream IP phones, Polycom IP phones, etc. The template MUC file can also be generated or modified from an existing MUC file used in a previous provisioning process. Once a template MUC file is determined to be available, an MUC file is generated (208) for the current provisioning process based on the template MUC file, the phone provisioning parameters and the phone configuration format. For example, if the template MUC file is determined to have all the parameters matching with those obtained at step 202, have each parameter associated with a corresponding key, and have a format conforming to the phone configuration file format obtained at step 204, the template MUC file can be copied and renamed to generate the MUC file for the current provisioning process.

If, however, the template MUC file has different parameters, non-associated parameters, or different configuration formats, the MUC file for the current provisioning process may be generated by modifying the template MUC file as needed. The modification of the template MUC file can be done by a software program or a utility tool. The modification can also be done manually by using, for example, text editors.

If a template MUC file is determined (206) to be not available, whether a sample configuration file is available is then determined (210). As discussed above, a sample configuration file may be provided by the phone manufacturer and can be in any text file format. A sample configuration file may include some or all of the parameters needed for the current provisioning process and has a conforming configuration file format. A sample configuration file, however, does not have keys enclosed by markup tags. And a sample configuration file may have data values that do not correspond to phones in the current provisioning process. Thus, a sample configuration file can be used as a base file for generating the MUC file.

Once the sample configuration file is determined to be available, an MUC file for the current provisioning process can be generated (212) based on the sample configuration file, the phone provisioning parameters and the phone configuration format. As an example, for the parameters that are phone-specific, their corresponding data values in the sample configuration file can be replaced with keys enclosed by markup tags such as “#”, “%”, or any other customized symbols or characters. On the other hand, for the parameters that are common across all phones in the current provisioning process, their corresponding data values in the sample configuration file can be replaced with desired data values. The format of the sample configuration file can also be modified, if necessary, to conform to that obtained at step 204. The modification of the sample configuration file can be done by a software program or a utility tool. The modification can also be done manually by using, for example, text editors.

As an example, a sample configuration file provided by a manufacturer is shown as following.

```
<?xml version=“1.0” encoding=“UTF-8” standalone=“yes”?>
<!-- Generated reg-basic.cfg Configuration File -->
<polycomConfig xmlns:xsi=“http://www.w3.org/2001/
XMLSchema-instance”
xsi:noNamespaceSchemaLocation=“polycomConfig.xsd”>
  <call call.callsPerLineKey=“24”>
  </call>
  <reg reg.1.address=“” reg.1.auth.password=“” reg.1.auth.userId=“”
reg.1.label=“” reg.1.outboundProxy.address=“” reg.2.address=“”
reg.2.auth.password=“%%” reg.2.auth.userId=“” reg.2.label=“”
reg.2.outboundProxy.address=“”>
  </reg>
</polycomConfig>
```

The corresponding MUC the generated based on the above sample configuration the is shown as following.

```
<?xml version=“1.0” encoding=“UTF-8” standalone=“yes”?>
<!-- Generated reg-basic.cfg Configuration File -->
<polycomConfig xmlns:xsi=“http://www.w3.org/2001/
XMLSchema-instance”
xsi:noNamespaceSchemaLocation=“polycomConfig.xsd”>
  <call call.callsPerLineKey=“24”>
  </call>
<reg reg.1.address=“%ADDR1%” reg.1.auth.password=“”
reg.1.auth.userId=“%MAC%” reg.1.label=“%LABEL1%”
reg.1.outboundProxy.address=“%ADDR1%” reg.2.address=“%ADDR2%”
reg.2.auth.password=“” reg.2.auth.userId=
“%MAC%” reg.2.label=“%LABEL2%”
reg.2.outboundProxy.address=“%ADDR2%”>
  </reg>
</polycomConfig>
```

In the above example, the phone-specific parameters, such as “reg reg. 1 .address” and “reg. 1 .auth.userId,” are assigned keys enclosed by markup tags, such as “%ADDR1%” and “%MAC%,” respectively.

If a sample configuration file is determined (210) to be not available, an MUC file can be generated based on just the phone provisioning parameters obtained at step 202 and the phone configuration file format obtained at step 204. In this situation, a text editor or a utility program can be invoked to enter the required phone provisioning parameters and their corresponding keys, and generate an MUC file that conforms to the configuration file format.

It can be appreciated by those skilled in the art that step 202 and step 204 can be skipped if the phone provisioning parameters and phone configuration file format are already known. It can also be appreciated by those skilled in the art that additional steps can be included anywhere in the flowchart shown in FIG. 2 to alter the decision flow.

FIG. 3 is a flowchart representing an exemplary method (300) for generating phone provisioning configuration files, as shown in FIG. 1. After initial step 301, the method (300) comprises obtaining (302) a first file, known as an MUC file and including one or more keys corresponding to phone provisioning configurations; obtaining (304) a set of variables and at least one set of data values from a second file, known as a CD file, the data values corresponding to the phone provisioning configurations of at least one phone; determining (308) whether an end of the second file is reached; if the end of the second file is not reached, obtaining (310) one or more sets of data values from the second file, wherein the one or more sets of data values correspond to the phone provisioning configurations of one or more phones; determining (312) whether number of the data values in at least one set of the data values corresponds to number of the variables; and generating (340) at least one phone provisioning configuration file corresponding to the data values based on the first file, when the number of data values in at least one set of the data values corresponds to number of the variables.

In some exemplary embodiments, at step 310, more than one set of data values or all sets of data values in the CD file can be obtained and more than one configuration file can be generated accordingly at step 340. In other exemplary embodiments, one set of data values is obtained at step 308 and one phone provisioning configuration file is generated at step 340. Steps 308˜340 are then repeated until all sets of data values in the CD file are obtained and the corresponding phone configuration files are generated. Referring to FIG. 3, one of ordinary skill in the art will readily appreciate that the illustrated procedure can be altered to delete steps or further include additional steps.

After initial step 300, an MUC file is obtained (302). An MUC file can be generated, for example, by the exemplary method 200 as discussed above. In some exemplary embodiments, an MUC file can include provisioning parameters and keys corresponding to phones that have the same phone model or same firmware version. In other exemplary embodiments, an MUC file can include provisioning parameters and keys corresponding to phones that have different phone models or different firmware versions. The obtained MUC file can be store on a memory device, such as a system memory or cache, a hard disk, or any other storage devices.

At step 304, a set of variables in a CD file can be obtained. As discussed above, a CD file can include, for example, a header row having variables corresponding to keys in the MUC file, and many data rows having sets of data values. A CD file is usually created by a user who has phone-specific data. The variables in a CD file can be delimited by delimiters such as symbols or special characters. The delimiters are for detecting or recognizing the variables in the CD file. In the CD file example as illustrated above, the delimiters are commas, for both the variables and data values. The four variables, i.e., FileName, MAC, IP, and DisplayName, can be obtained by reading the first row the CD file and parsing the first row based on the delimiters, i.e., the commas. One of ordinary skill in the art will readily appreciate that any other variable-recognizing method may also be used to obtain the variables from a CD file.

At step 308, the exemplary system determines whether the end of the CD file is reached. In a CD file, the header row and the data rows can be delimited by row delimiters, e.g., line breaks. Thus, a header row having a set of variables can be separated from the data rows by a row delimiter. After step 304, it is determined whether one or more data rows follow the header row in the CD file. If the CD file only includes a head row and no data row, the end of the CD file is reached and the method proceeds to a stop 380. If, however, the CD file has one or more data rows, the data values are obtained (310). In some exemplary embodiments, one data row includes one set of data values that correspond to one phone that is being provisioned. That is, each data row in the CD file includes data values of one particular phone. Row delimiters such as line breaks can also be used as delimiters of the data rows. One of ordinary skill in the art can readily appreciated that the CD file format is not limited to a head row followed by data rows. The variables and data values can be arranged in any order, as long as each data value can be associated with a particular variable and each set of data value can be associated with a particular phone.

At step 312, it is determined whether the number of obtained data values in each set equals the number of the variables. For example, if each data row includes data values of one particular phone, it is then determined whether the number of data values in each data row equals the number of variables in the header row. The number of data values in each row and the number of variables can be determined based on the delimiters in each row. In some exemplary embodiments, a counter, such as a count-up counter, can be used for counting the number of variables and the number of data values. The numbers can be stored in a memory device, such as a computer memory or cache, a hard disk, or any other storage devices.

At step 312, if the number of data values in any data row does not equal the number of variables in the header row, it indicates that there is a mismatch between the variables and the data values. That is, either some data values are not associated with variables, or vice versa. The method can thus proceed to a stop 380. If the numbers are equal, the method proceeds to generate (340) at least one phone provisioning configuration file corresponding to the one or more sets of data values. Details of the phone configuration file generation will be discusses in association with FIG. 4. In some exemplary embodiments, however, if the number of at least one set of data values, but not all, equals the number of variables, the method can still choose to proceed to step 340 to generate at least one phone provisioning configuration file based on the matched sets, ignore the mismatched sets, and report an error message.

In some exemplary embodiments, one set of data values is obtained at step 310 for each configuration file generation at step 340. Steps 308˜340 can be repeated until the end of the CD file is reached, i.e., until all sets of the data values in the CD file are obtained and all the corresponding phone configuration files are generated.

In the exemplary method 300, any number of phone provisioning configuration files can be generated provided that the CD file containing the same number of phone-specific data sets are available. Thus, the inconvenience of switching between multiple utilities programs, programming overheads, and command-line inputs can be avoided.

In some exemplary embodiments, different configuration files corresponding to different phone models, firmwares, etc., can be generated by modifying an existing MUC file or creating a new MUC file, as discussed in association with FIG. 2. The MUC file modification or creation, however, is only a one-time process for generation of a large number of configuration files. In other exemplary embodiments, the MUC file can even be developed to include parameters and keys corresponding to different phone models or firmware versions. Thus, configuration files for different phone models or firmwares can be generated using the same MUC file, provided that the CD file has the required data values. Regardless whether the same MUC file is used, only one utility tool is needed and the amount of effort and cost associated with generating of a large number of provisioning configuration files may be greatly reduced.

Moreover, when a user needs to provision a new phone or to change settings of an existing phone, conventional methods requires the user to enter, at a command-line or a Graphic User Interface (GUI), all the variables and data values that need to be changed. As a result, when the numbers of variables and/or data values are large, the command-line or GUI inputs can become quite cumbersome. This problem may be somewhat avoided by limiting the number of variables and the data values. For example, the number of variables can be limited by hard-coding some of the variables to have permanent data values. The hard-coding of variables, however, compromises flexibility for generating phone configuration files and thus is generally not desired.

The subject matter of this application, e.g., the method 300 as described above, may solve the effort-flexibility dilemma. The MUC file, which can include any number of keys, may eliminate the need for manually entering all the variables in a command-line each time when a configuration file is generated. At the same time, the MUC file provides great flexibility because it does not require hard-coding of variables. Thus, for generating the phone configuration files, the user would only need to generate an MUC file, which is a one-time process, and provide the CD file, which includes the phone-specific data values. In addition, if a CD file needs to be edited to modify data values, editing of the CD file may be easily performed, for example, by a global search and replace. Furthermore, the number of variables in the CD file, or corresponding keys in the MUC file, is unlimited so that great flexibility can be obtained.

FIG. 4A is a flowchart representing a first embodiment of the exemplary method (340) for generating a phone configuration file, as shown in FIG. 3. Referring to FIG. 4A, one of ordinary skill in the art will readily appreciate that the illustrated procedure can be altered to delete steps or further include additional steps. The first embodiment of the exemplary method (340) comprises generating (342) at least one copy of the first file; determining (344) whether the one or more keys in the first file correspond to the variables in the CD file; replacing (346) one or more keys in at least one copy of the first file with corresponding data values, when the keys in the first file correspond to the variables in the second file; determining (348) whether all keys in the at least one copy of the first file are replaced with corresponding data values; and generating (350) the at least one phone configuration file, wherein the at least one phone configuration file has a unique file name.

After initial step 341, a copy of the MUC file is generated (342) based on the MUC file obtained at step 302 shown in FIG. 3. In some exemplary embodiments, a copy of the MUC file is needed for each set of the data values when more than one phone configuration file are generated with the same MUC file. That is, generating of each phone configuration file requires one copy of the MUC file. Copies of MUC files can be stored in a memory device, such as a computer memory or cache, a hard disk, or any other storage devices.

At step 344, it is determined whether each of the variables in the CD file corresponds to at least one key in the MUC file. As discussed above, in some exemplary embodiments, the variables in the CD file and the keys in the MUC file have a one-to-one association. But in some exemplary embodiments, the number of keys may not equal the number of variables. For example, one variable can correspond to more than one key.

For illustration purpose, an exemplary MUC file may include the following lines.

SIP_SERVER = 10.1.16.25 //Same for all phones
MAC_ADR = <MAC>
DISP_NAME = <DISPLAY NAME>
DEVICE_ID = <DEVICE ID>

The “MAC”, “DISPLAY NAME” and the “DEVICE ID” are keys, which can be replaced with different data values corresponding to different phones. Each of the keys is enclosed by an opening tag “<” and a closing tag “>.” The “10.1.16.25” is not a key, but a permanent data value and is the same for all phones. A CD file corresponding to this MUC file may include the following lines.

| | | | DEVICE |
|---|---|---|---|
| FILE NAME, | MAC, | DISPLAY NAME, | ID |
| 0011223344_XYZ.cfg, | 0011223344, | Peter, | 12345 |
| 0011223355_XYZ.cfg, | 0011223355, | John, | 12346 |
| 0011223366_XYZ.cfg, | 0011223366, | Sam, | 12347 |

Consistent with the foregoing discussion, in some exemplary embodiments, the first row in the CD file can be a header row having variables. In the above example, the variables are “FILE NAME,” “MAC,” “DISPLAY NAME,” and “DEVICE ID.” The “FILE NAME” is a variable that can be used for naming the phone configuration file, as will be discussed in step 350.

In the above example, at step 344, a key in the MUC file is compared to the variables, e.g., “MAC,” “DISPLAY NAME,” and “DEVICE ID,” in the CD file and determined whether the corresponding variable can be found. In some exemplary embodiments, if no corresponding variable can be found, the method proceeds to a stop 360. In some exemplary embodiments, however, the method can still proceed to compare the next key, i.e., repeat step 344, to the variables even if no corresponding variable can be found for the current key. Step 344 can be performed, for example, by any standard or customized search and compare routine in any programming language. As an example, in Python, a compare routine, such as “any([s for s in strings if s==key]),” can be used, where the “strings” represent the variables in the CD file and the “key” represent the key that is being compared. As another example, a similar routine, such as “std::find(strings.begin( ), strings.end( ), key) != v.end( ),” in C++ using STL, can also be used.

At step 346, when the key in the MUC file is determined to have an associated variable in the CD file, the key in the copy of the MUC file is replaced with a corresponding data value. In the above example, the key “MAC” in the first copy of the MUC file can be replaced with “0011223344;” the key “MAC” in the second copy of the MUC file can be replaced with “0011223355;” and so forth. The replacing or substituting operation can be done by any standard or customized replacing routines in any programming language. For example, if the number of key replacements does not exceed ten thousand, e.g., replacing 10 parameters of 1000 phones, and running time is not crucial, it may be acceptable to use standard substring replacement functions which are usually built-in functions in modern programming languages.

In some exemplary embodiments, the replacing functions replace all occurrences of substring “fromText” with “toText” in a given “text.” The algorithms behind the replacing functions may vary depending on the programming language. As examples, in Python, the replacing function may be: string.replace(text, fromText, toText). And in C++ using STL, the replacing function may be std::replace( text.begin( ), text.end( ), fromText, toText). If, on the other hand, the number of key replacements is large, e.g., exceeds ten thousand, a customized replacing function can be developed for fast-speed replacement.

At the optional step 348, it is determined whether all keys in the MUC file are replaced with data values. In the above example, the CD file includes three data rows corresponding to three phones. Each data row has three variables, excluding the file name variable. And there are total of three keys in the exemplary MUC file, i.e., “MAC,” “DISPLAY NAME,” and “DEVICE ID.” Thus, if it is determined that not all the three keys are replaced with their proper data values, step 344˜step 346 may be repeated until all the keys in each copy of the MUC file are replaced with the data values from the CD file. Moreover, as another example, keys that do not have corresponding variables in the CD file may be subsequently replaced, such as manually replaced, with data values in a later step (not shown in FIG. 4A). The keys that are replaced in a later step can be associated with, for example, parameters that are common among all the phones.

At step 350, a phone configuration file can be generated, wherein the phone configuration file has a unique file name. The unique file name can be obtained based on a unique identification of the phone. In the example above, the MAC address, such as “0011223344” can be incorporated in the file name, i.e., “0011223344_XYZ.cfg,” in order to make the file name unique. It is readily appreciated by those of ordinary skill in the art that any unique identifier can be used for the file name. In the above example, by replacing the keys with data values in the first row of the CD file, a configuration file generated has a file name as “0011223344_XYZ.cfg” and includes lines as following.

SIP_SERVER = 10.1.16.25 //Same for all phones
MAC_ADR = 0011223344
DISP_NAME = Peter
DEVICE_ID = 12345

The configuration files generated can be stored on a memory, a hard disk, or any storage devices. For example, the configuration files can be stored on the hard disk of a provisioning server so that they can be accessed by a later provisioning process.

FIG. 4B is a flowchart representing a second embodiment of the exemplary method (340) for generating a phone configuration file, as shown in FIG. 3. Referring to FIG. 4B, one of ordinary skill in the art will readily appreciate that the illustrated procedure can be altered to delete steps or further include additional steps. The second embodiment of the exemplary method (340) comprises generating (372) at least one copy of the first file; determining (374) whether the variables obtained from a second file correspond to one or more keys in the first file; replacing (376) one or more keys in at least one copy of the first file with corresponding data values, when the variables in the second file correspond to the keys in the first file; determining (378) whether all data values of a phone replaced the corresponding keys in at least one copy of the first file; and generating (380) the at least one phone configuration file, wherein the at least one phone configuration file has a unique file name.

After initial step 371, a copy of the MUC file is generated (372) based on the MUC file obtained at step 302 shown in FIG. 3. In some exemplary embodiments, a copy of the MUC file is needed for each set of the data values when more than one phone configuration file are generated with the same MUC file. That is, generating of each phone configuration file requires one copy of the MUC file. Copies of MUC files can be stored in a memory device, such as a computer memory or cache, a hard disk, or any other storage devices.

At step 374, it is determined whether a variable in the CD file corresponds to a key in the MUC file. As discussed above, in some exemplary embodiments, the variables in the CD file and the keys in the MUC file may have a one-to-one association. When the variables and keys have a one-to-one association, step 374 may be optional. For example, when each variable is known to correspond to a key in a preset order, there may not be a need to determine whether the variable has a corresponding key and step 374 can be skipped.

In some exemplary embodiments, it may be determined, at step 374, that a variable does not have a corresponding key in the MUC file. If a variable does not have a corresponding key, the method may proceed to a stop 390. In some exemplary embodiments, however, the method can still proceed to determine whether the next variable has a corresponding key, i.e., the method can repeat step 374, even if no corresponding key can be found for the current variable.

At step 376, a key in the copy of the MUC file is replaced with the corresponding data value if, at step 374, the current or next variable is determined to have a corresponding key in the MUC file, or if step 374 is skipped because the variables and keys are known to correspond to each other.

At the optional step 378, it is determined whether all data values of a phone replaced the corresponding keys in the copy of the MUC file. If it is determined that not all the data values replaced the corresponding keys, steps 374˜376 may be repeated. In some exemplary embodiments, all data values from the CD file replace their corresponding keys. In some exemplary embodiments, however, some data values from the CD file may not replace any key if, for example, their corresponding keys cannot be determined.

At step 380, a phone configuration file can be generated, wherein the phone configuration file has a unique file name. Similar to the first embodiment of the method 340, if the phone configuration file generated at step 380 still has some keys that are not replaced with data values, the keys may be subsequently replaced, such as manually replaced, with data values in a later step (not shown in FIG. 4B). The keys that are replaced in a later step can be associated with, for example, parameters that are common among all the phones. One of ordinary skill in the art would appreciate that the first and second embodiments of the method 340 are for illustration purpose only, and method 340 can have other embodiments.

The methods disclosed herein may be implemented as a computer program product, i.e., a computer program tangibly embodied in an information carrier, e.g., in a machine-readable storage device, for execution by, or to control the operation of, data processing apparatus, e.g., a programmable processor, a computer, or multiple computers. A computer program can be written in any form of programming language, including compiled or interpreted languages, and it can be deployed in any form, including as a standalone program or as a module, component, subroutine, or other unit suitable for use in a computing environment. A computer program can be deployed to be executed on one computer or on multiple computers at one site or distributed across multiple sites and interconnected by a communication network.

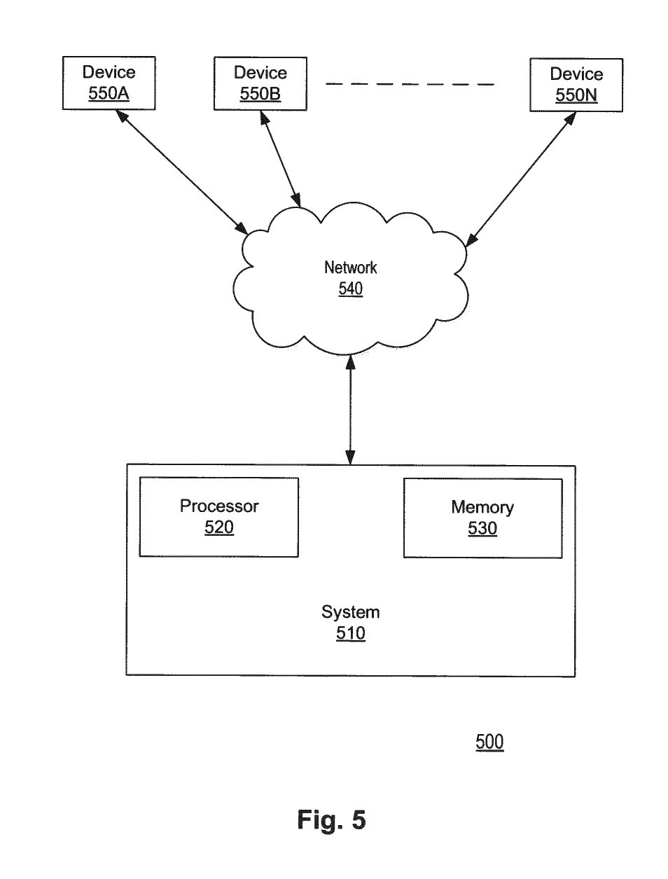

FIG. 5 is a block diagram 500 of an exemplary provisioning system. The methods disclosed herein may be implemented on the system 500. The exemplary system 500 can be any type of network system that can be used for transmitting data across wired or wireless networks to devices that need provisioning. The exemplary system 500 can include, among other things, a computer system 510, a network 540 and at least one device 550 (e.g., 550A˜550N) that needs provisioning.

The computer system 510 can be any type of computing system such as a server, a desktop computer, or a mobile computer. The computer system 510 can have at least one processor, such as processor 520, and at least one memory for storing program instructions, such as memory 530. The processor(s) can be a single or multiple microprocessors, field programmable gate arrays (FPGAs), or digital signal processors (DSPs) capable of executing particular sets of instructions. For example, the processor 520 can execute instructions for generating the provisioning configuration files.

Computer-readable instructions can be stored on a tangible non-transitory computer-readable medium, such as a flexible disk, a hard disk, a CD-ROM (compact disk-read only memory), and MO (magneto-optical), a DVD-ROM (digital versatile disk-read only memory), a DVD RAM (digital versatile disk-random access memory), or a semiconductor memory. For example, computer-readable instructions can be stored on memory 530. In addition, the provisioning configuration files generated by the processor 520 can also be stored on memory 530. Alternatively, the methods can be implemented in hardware components or combinations of hardware and software such as, for example, ASICs, special purpose computers, or general purpose computers.

Network 540 can be any type of network such as a wired network, a radio network, a wide area network (WAN), a local area networks (LAN), or a wireless network suitable for data communications, such as Internet communications. In a provisioning process, network 540 can be used, for example, for transmitting the provisioning configuration files stored on memory 530 to devices 550A˜550N, which are devices that require provisioning. Such devices can include VoIP phones, mobile phones, cordless phones, or any other devices that require provisioning.

In the preceding specification, the subject matter has been described with reference to specific exemplary embodiments. It will, however, be evident that various modifications and changes may be made without departing from the broader spirit and scope of the invention as set forth in the claims that follow. The specification and drawings are accordingly to be regarded as illustrative rather than restrictive. Other embodiments may be apparent to those skilled in the art from consideration of the specification and practice of the embodiments disclosed herein.

What is claimed is:

1. A method for generating a phone provisioning configuration file, comprising:
obtaining a first file, the first file including one or more keys corresponding to phone provisioning configurations;
obtaining a set of variables and at least one set of data values from a second file, the data values corresponding to the phone provisioning configurations of at least one phone;
determining whether a number of the data values in the at least one set of data values corresponds to a number of the variables; and
generating at least one phone provisioning configuration file corresponding to the data values based on the first file, when the number of data values in the at least one set of data values corresponds to the number of variables.

2. The method of claim 1, wherein the first file includes one or more keys associated with markup tags.

3. The method of claim 2, wherein at least one of the markup tags is a combinational tag.

4. The method of claim 1, wherein each data value in a set has a corresponding variable.

5. The method of claim 1, wherein each set of the data values includes a unique identifier for naming each of the at least one phone provisioning configuration file.

6. The method of claim 1, wherein the variables and the data values are delimited.

7. The method of claim 1, wherein the generating at least one phone provisioning configuration file comprises:
generating at least one copy of the first file;
determining whether the one or more keys in the first file correspond to the variables in the second file;
replacing one or more keys in at least one copy of the first file with corresponding data values, when the keys in the first file correspond to the variables in the second file; and
generating the at least one phone configuration file, wherein each of the at least one phone configuration files has a unique file name.

8. The method of claim 7, wherein replacing the one or more keys in at least one copy of the first file with corresponding data values further comprises:
substituting the one or more keys with the corresponding data values; and
removing markup tags that are associated with the keys.

9. The method of claim 1, wherein the generating at least one phone provisioning configuration file comprises:
generating at least one copy of the first file;
determining whether the variables in the second file correspond to the keys in the first file;
replacing one or more keys in at least one copy of the first file with corresponding data values, when the variables in the second file correspond to the keys in the first file; and
generating the at least one phone configuration file, wherein each of the at least one phone configuration files has a unique file name.

10. The method of claim 1, wherein the at least one phone provisioning configuration file comprises a configuration file for provisioning Internet Protocol (IP) phones.

11. A method for generating a first file having one or more keys, comprising:
obtaining at least one phone provisioning parameter;
obtaining a phone configuration file format;
determining whether a second file including sample configurations is available;
when the second file is available, generating the first file based on the second file, the at least one phone provisioning parameter, and the phone configuration file format; and
when the second file is not available, generating the first file based on the at least one phone provisioning parameter and the phone configuration file format.

12. The method of claim 11, wherein the one or more keys correspond to phone provisioning configurations and the keys are associated with markup tags.

13. A non-transitory computer-readable storage medium storing instructions that, when executed by a computer, cause the computer to perform a method for generating at least one phone provisioning configuration file, the method comprising:
obtaining a first file, the first file including one or more keys corresponding to phone provisioning configurations;
obtaining a set of variables and at least one set of data values from a second file, the data values corresponding to the phone provisioning configurations of at least one phone;
determining whether a number of the data values in the at least one set of data values corresponds to a number of the variables; and
generating at least one phone provisioning configuration file corresponding to the data values based on the first file, when the number of data values in the at least one set of data values corresponds to the number of variables.

14. The non-transitory computer-readable storage medium of claim 13, wherein the generating at least one phone provisioning configuration file comprises:
generating at least one copy of the first file;
determining whether the one or more keys in the first file correspond to the variables in the second file;
replacing one or more keys in at least one copy of the first file with corresponding data values, when the keys in the first file correspond to the variables in the second file; and
generating the at least one phone configuration file, wherein each of the at least one phone configuration files has a unique file name.

15. The non-transitory computer-readable storage medium of claim 13, wherein the at least one phone provisioning configuration file comprises a configuration file for provisioning Internet Protocol (IP) phones.

16. A non-transitory computer-readable storage medium storing instructions that, when executed by a computer, cause the computer to perform a method for generating a first file having one or more keys, the method comprising:
obtaining at least one phone provisioning parameter;
obtaining a phone configuration file format;
determining whether a second file including sample configurations is available;
when the second file is available, generating the first file based on the second file, the at least one phone provisioning parameter, and the phone configuration file format; and
when the second file is not available, generating the first file based on the at least one phone provisioning parameter and the phone configuration file format.

17. The non-transitory computer-readable storage medium of claim 16, wherein the one or more keys correspond to phone provisioning configurations.

18. A system for generating a phone provisioning configuration file, comprising:
a processor configured to
obtain a first file, the first file including one or more keys corresponding to phone provisioning configurations;
obtain a set of variables and at least one set of data values from a second file, the data values corresponding to the phone provisioning configurations of at least one phone;
determine whether a number of the data values in the at least one set of data values corresponds to a number of the variables; and
generate at least one phone provisioning configuration file corresponding to the data values based on the first file, when the number of data values in the at least one set of data values corresponds to the number of variables; and
a memory for storing the at least one phone provisioning file.

19. The system of claim 18, wherein the processor, for generating at least one phone provisioning configuration file, is configured to:
generate at least one copy of the first file;
determine whether the one or more keys in the first file correspond to the variables in the second file;
replace one or more keys in at least one copy of the first file with corresponding data values, when the keys in the first file correspond to the variables in the second file; and
generate the at least one phone configuration file, wherein each of the at least one phone configuration files has a unique file name.

20. The system of claim 18, wherein the at least one phone provisioning configuration file comprises a configuration file for provisioning Internet Protocol (IP) phones.
